(19) United States
(12) Patent Application Publication
(10) Pub. No.: US 2006/0144369 A1
(43) Pub. Date: Jul. 6, 2006

(54) Engine

(76) Inventors: Masanori Takahashi, Hamamatsu-shi (JP); Toshiaki Tsujioka, Hamamatsu-shi (JP); Satoshi Miyazaki, Hamamatsu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/300,134

(22) Filed: Dec. 14, 2005

(30) Foreign Application Priority Data
Dec. 14, 2004 (JP) 2004-361826

(51) Int. Cl. F02M 61/14; F01L 1/053

(52) U.S. Cl. 123/470; 123/90.27

(57) ABSTRACT

An internal combustion engine includes an intake conduit, a valve drive unit configured for driving an intake valve and a fuel injector. A cylinder head is formed by casting. The intake conduit is coupled to an intake port formed in the cylinder head through an intake passage also formed in the cylinder head. The fuel injector is positioned between the intake passage and the valve drive unit. The cylinder head further comprises a valve drive unit mounting portion and a fuel injector mounting portion. The valve drive unit mounting portion and the fuel injector mounting portion at least partially overlap with each other when looking in a direction of an axis of the crankshaft.

### PRIORITY INFORMATION

This application is based upon and claims priority to Japanese Patent Application No. 2005-361826, filed on Dec. 14, 2004, the entire contents of which are hereby incorporated by reference herein.

### BACKGROUND OF THE INVENTION

1. Field of the Invention

This invention relates to an engine and, more particularly, this invention relates to an engine for an outboard motor

2. Description of the Related Art

Some land vehicles have engines with a fuel injection system. For example, JP-A-2004-144100 discloses a fuel injection system that incorporates a fuel injector, which is positioned adjacent to an intake port. By positioning the fuel injector adjacent to the intake port, sprayed fuel does not adhere onto an inner surface of an intake conduit.

In an outboard motor, the engine has a crankshaft that extends in a generally vertical direction. The engine is typically disposed within a cowling Due to a relatively narrow space within the cowling, an air inlet for the engine can be positioned on a side of a crankcase of the engine. An intake conduit can extend from the air inlet along a lateral side of the engine and can be coupled to an intake port through an intake passage.

### SUMMARY OF THE INVENTION

One aspect of the present invention is the recognition that if a fuel injector as disclosed in JP-A-2004-144100 is provided in an outboard motor as described above, the fuel injector and a fuel rail associated with the fuel injector would protrude outward between the intake passage, which is generally U-shaped, and an intake valve. Consequently, the cowling that surrounds the engine would need to be larger.

Another aspect of the present invention is the recognition that in a V-type engine, which has cylinder banks that extending horizontally in V-shape, a more notable problem exists. In such an engine, a side-feed type fuel injector as disclosed in JP-A-Hei09-280141 can replace the fuel injector system discussed above. However, the side-feed type fuel injector has a structure more complicated than conventional fuel injectors, and thus can be expensive. Therefore, it has been preferable to continue to use the conventional fuel injector.

Another aspect of the present invention is the recognition that the structure disclosed in JP-A-2004-144100 can allow the sprayed fuel to adhere onto an inner surface of the intake passage on the way to the intake valve. Specifically, the intake passage can bifurcate into two passage portions. In an engine for an outboard motor, the crankshaft extends vertically and the two passage portions form upper and lower passage portions. Fuel that adheres onto an inner surface of the upper passage portion can fall down to the lower passage portion and can be taken into a lower intake port through the lower passage portion. As a result, the amount of the fuel in the intake stroke can be uneven, which can cause unexpected combustion. In order to solve this problem, it is generally preferred that an injection axis of the fuel injector along which the fuel is sprayed does not intersect with an area of the inner surface of the intake passage. However, this arrangement can cause another problem limiting the design of the fuel injection system.

Therefore, one object of the present invention is to provide a smaller engine in which the fuel injector does not significantly protrude. Another object of the presenting invention is to provide an engine in which an amount of fuel adhered onto an inner surface of an intake passage can be reduced without limiting choice of configurations (or increasing the choices available) of the intake passage.

Accordingly, one aspect of the present invention comprises an n internal combustion engine that includes an intake conduit, a valve drive unit configured for driving an intake valve and a fuel injector. A cylinder head is formed by casting. The intake conduit is coupled to an intake port formed in the cylinder head through an intake passage also formed in the cylinder head. The fuel injector is positioned between the intake passage and the valve drive unit. The cylinder head further comprises a valve drive unit mounting portion and a fuel injector mounting portion. The valve drive unit mounting portion and the fuel injector mounting portion at least partially overlap with each other when looking in a direction of an axis of the crankshaft.

Another aspect of the present invention comprises an internal combustion engine, that includes a cylinder head that is formed by casting. The cylinder head forms at least in part an intake port that is in communication with a combustion chamber and an intake passage that extends from the intake port. An intake conduit is in fluid communication with the intake passage. A valve drive unit is configured for driving an intake valve that is configured to at least partially open and close the intake port. A fuel injector is positioned between the intake passage and the valve drive unit. The cylinder head further comprises a valve drive unit mounting portion and a fuel injector mounting portion. The valve drive unit mounting portion defines at least in part a wall having a thickness and having an extension that extends in a direction generally parallel to a longitudinal axis of the intake valve toward the intake port. The fuel injector mounting portion forms an annular boss having a radial thickness and an extension that extends generally about an injection axis of the fuel injector towards the intake port. The extensions of the valve drive unit mounting portion and the fuel injector mounting portion at least partially overlap with each other when looking in a direction of an axis of the crankshaft.

Another aspect of the present invention comprises an internal combustion engine, that includes a cylinder head that is formed by casting. The cylinder head forms at least in part an intake port that is in communication with a combustion chamber and an intake passage that extends from the intake port. An intake conduit is in fluid communication with the intake passage. A valve drive unit is configured for driving an intake valve that is configured to at least partially open and close the intake port. A fuel injector is positioned between the intake passage and the valve drive unit. The engine further comprises means for supporting the valve drive unit and means for supporting the fuel injector mounting portion. The means for supporting the valve drive unit and means for supporting the fuel injector mounting portion at least partially overlap with each other when looking in a direction of an axis of the crankshaft.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein

### BRIEF DESCRIPTION OF THE DRAWINGS

A general structure that implements various features of specific embodiments of the invention will now be described with reference to the drawings. The drawings and the associated descriptions are provided to illustrate embodiments of the invention and not to limit the scope of the invention.

FIG. 1 is a side elevational view of an outboard motor mounted on a watercraft.

FIG. 2 is a transverse cross sectional view of an engine of the outboard motor.

FIG. 3 is a transverse cross sectional view of a valve drive unit of the engine.

FIG. 4 is a cross sectional view showing a valve drive unit mounting structure and a fuel injector mounting structure.

FIG. 5 is a cross sectional view of an anode mounting portion.

FIG. 6 is an illustration showing an engine that has a wide bank angle.

FIG. 7 is an illustration showing an engine that has a narrow bank angle.

FIG. 8 is an illustration showing an embodiment in which a camshaft is positioned closer to a center axis of an intake valve.

### DETAILED DESCRIPTION OF THE PREFERRED EMBODIMENTS

Embodiments of an engine having certain features and aspects according to the present invention will now be described in these embodiments, the engine is described in the context of an outboard motor. The engine is described in the context of an outboard motor because certain features and aspects of the present invention are particularly advantageous in an outboard motor. However, it is anticipated that various features, aspects and advantages of the engine described herein can be applied to other applications, such as, for example, other marine applications, land vehicles, and/or stationary applications.

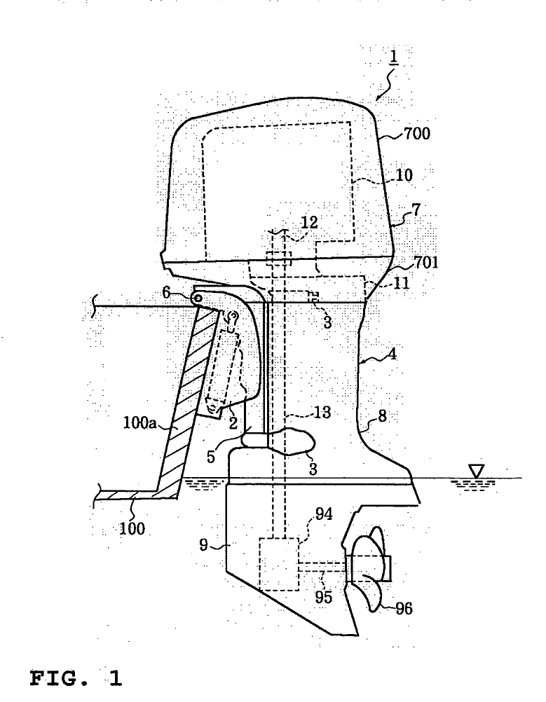

FIG. 1 is a side elevational view of an outboard motor 1 that can be mounted on a watercraft. The outboard motor 1 in this embodiment can be coupled to a transom board 100a of a hull 100 by a clamping bracket 2. A swivel bracket 5 can elastically support a propulsion unit 4 through upper and lower dampers 3. The swivel bracket 5 can be coupled with the clamping bracket 2 for pivotal movement in a vertical direction about an axis of a tilt shaft 6.

The propulsion unit 4 can have a housing, which is formed with a cowling 7, an upper casing 8 and a lower casing 9. The cowling 7 can include a top cowling 700 and a bottom cowling 701. The cowling 7 can surrounds a four stroke engine 10, which will be described in detail below. The upper casing 8 can be fixed to a bottom portion of an exhaust guide 11. The exhaust guide 11 can support the engine 10.

A crankshaft 12 can extend vertically through the engine 10. A driveshaft 13 can extend vertically through the upper casing 8. A top end of the driveshaft 13 can be coupled to the crankshaft 12. A bottom end of the driveshaft 13 can be coupled to a forward/reverse change mechanism 94 housed in the lower casing 9. A propeller shaft 95 can extend horizontally from the forward/reverse change mechanism 94. A propeller 96 can be coupled to a rear end portion of the propeller shaft 95 that protrudes outside from the lower casing 9.

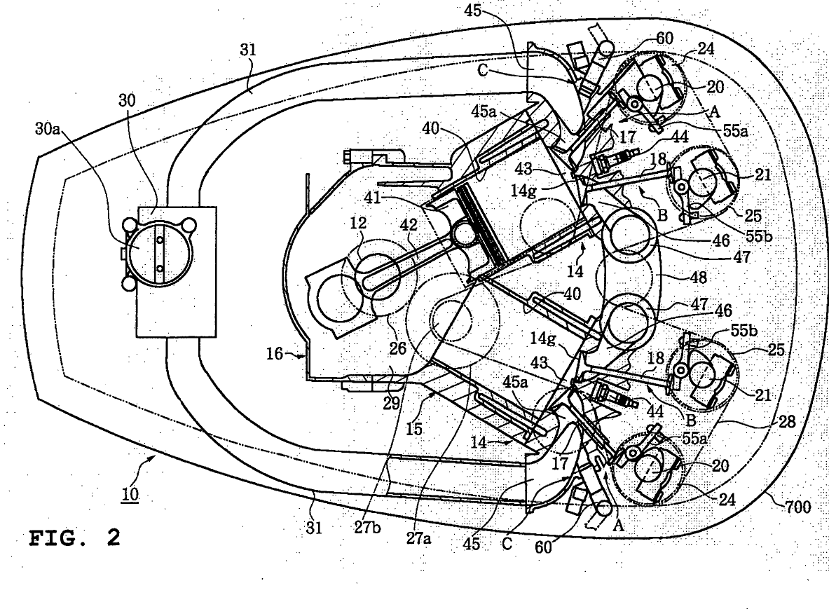

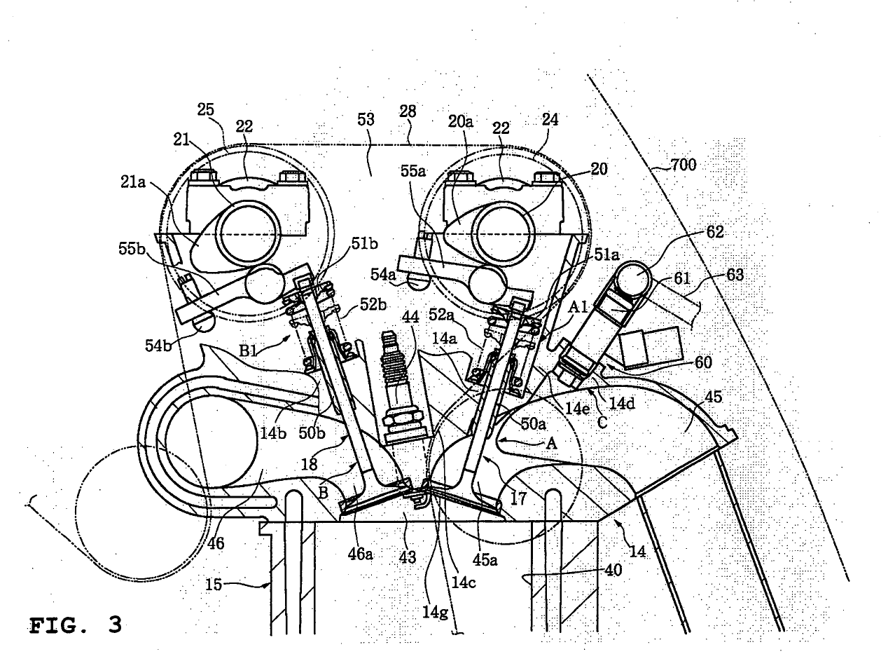

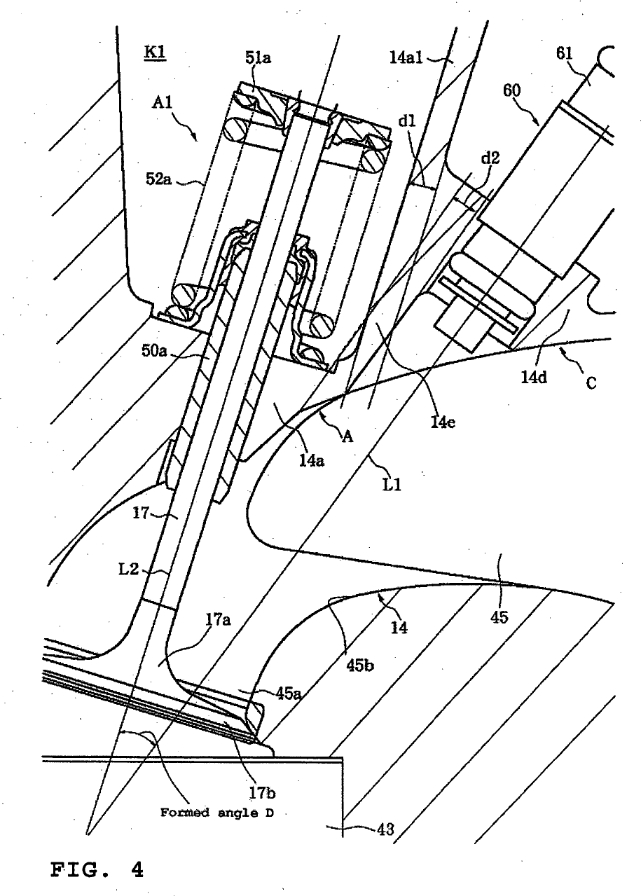

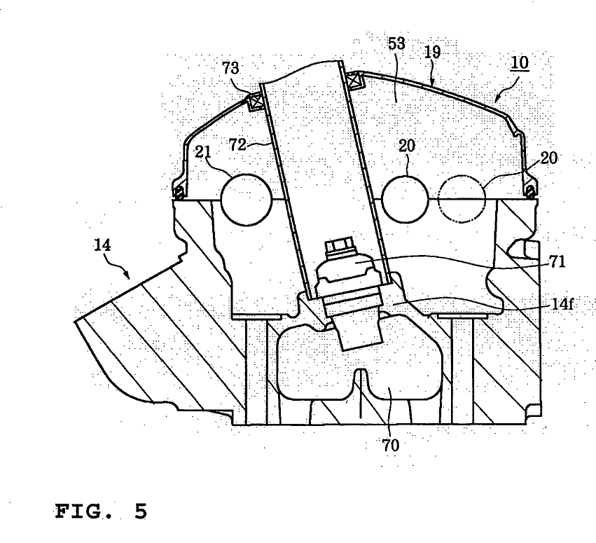

With reference to FIGS. 2 through 5, a structure of the engine 10 according an embodiment of the present invention will be described. FIG. 2 is a transverse cross sectional view of the engine. FIG. 3 is a transverse cross sectional view of a valve drive unit of the engine. FIG. 4 is a cross sectional view showing a valve drive unit mounting structure and a fuel injector mounting structure. FIG. 5 is a cross sectional view of an anode mounting portion.

As will be described below, the engine 10 of the illustrated embodiment is a four-stroke, V-type, multiple-cylinder type engine. However, it should also be appreciated that various features, aspects and advantages of the present invention may be used with engines operating on different cycles (e.g., 2-cycle) and having any of a variety of configurations including a different numbers of cylinders and different cylinder arrangements (W, opposing, etc.).

With initial reference to FIGS. 2-4, the engine 10 surrounded by the cowling 7 in this embodiment can be a water-cooled, four stroke, V-type, DOHC engine. The main body of the engine 10 can include a head cover 19, a cylinder head 14, a cylinder block 15m which forms a cylinder body and a portion of a crank chamber 29 and a crank case 16. All the components 19, 14, 15, 16 preferably can be unitarily coupled one by one in this order in a fore to aft direction of the outboard motor 1. That is, the crankcase 16 can be placed at the most forward position, while the head cover 19 can be placed at the most rear position.

The cylinder block 15 can have two banks extending in a V-shape. Each bank can have a plurality of cylinders extending in a generally horizontal direction. With the cylinder block 15, respective cylinder bores 40 are positioned above one another. A piston 41 can be reciprocally disposed in each cylinder bore 40. An end of a connecting rod 42 can be coupled to each piston 41, while another end of the connecting rod 42 can be coupled to the crankshaft 12. A combustion chamber 43 can be formed between a head portion of each piston 41 and a recess 14g of the respective cylinder head 14 in each cylinder bore 40. Each cylinder head 14 can have an ignition plug 44, which is exposed to the respective combustion chamber 43.

The cylinder head 14 can form an intake passage 45 and an exhaust passage 46 for each cylinder. The intake and exhaust passages 45, 46 communicate with the combustion chamber 43 through an intake port 45a and an exhaust port 46a, respectively. A plenum chamber (surge tank) 30 can be disposed in a forward area of the engine 10 (see FIG. 2). The plenum chamber 30 can be an air introducing portion of an intake passageway that is provided for supplying air to the respective combustion chambers 43 of the engine 10. The plenum chamber 30 can have an air inlet port 30a positioned at a top portion thereof. The air inlet port 30a can be located in front of the crankcase 16. A plurality of intake conduits 31 can extend from both sides of the plenum chamber 30 to the respective intake passages 45 along both sides of the engine 10. Each intake conduit 31 can communicate with the respective intake port 45a through the intake passage 45.

An exhaust conduit 47 can be connected to each cylinder. Each exhaust conduit 47 can also be connected to an exhaust manifold 48. The exhaust manifold 48 can extend vertically between the V-shaped banks. Exhaust gases passing through the exhaust manifold 48 can be discharged to the body of water through the exhaust guide 11 (see FIG. 1).

The cylinder head 14 has an intake valve 17 and an exhaust valve 18, which open or close the intake port 45a and the exhaust port 46a of each cylinder, respectively. Each intake or exhaust valve 17 and 18 moves between an open position and a closed position at a proper time to exchange gases in the respective cylinder as is well know in thee art.

Each intake valve 17 is inserted into a valve guide 50a, which can be press-fitted into the cylinder head 14 so as to be slidably supported by the valve guide 50a. A valve spring 52a can be disposed between the cylinder head 14 and a valve retainer 51a under a compressed condition. The valve spring 52a normally urges the associated intake valve 17 toward the closed position. Each exhaust valve 18 can be inserted into a valve guide 50b, which can be press-fitted into the cylinder head 14 such that the valve 18 is slidably supported by the valve guide 50b. Another valve spring 52b can be disposed between the cylinder head 14 and a valve retainer 51b under a compressed condition. The valve spring 52b normally urges the associated exhaust valve 18 toward the closed position.

Rocker arm shafts 54a, 54b can be disposed in a space (e.g., a cam chamber) 53 closed by the head cover 19 of the cylinder head 14. The rocker arm shafts 54a, 54b can support rocker arms 55a, 55b for swinging movement, respectively. An end of each rocker arm 55a, 55b can contacts a head portion of the respective intake or exhaust valves 17, 18. Another end of each rocker arm 55a, 55b can contact an outer circumferential surface of a cam 20a, 21a, which can be unitarily formed with the camshafts 20. 21.

When the engine 10 is in operation, the crankshaft 12 rotates the respective camshafts 20, 21. When each camshaft 20 and 21 rotates at certain speed, the rocker arms 55a, 55b that contacts the cams 20a, 21a (which can be unitarily formed with the camshaft 20 and 21) swing about an axis of the rocker arm shaft 54a, 54b along a profile of the cams 20a, 21a. Thus, the intake or exhaust valves 17, 18 can move between the open and closed positions at proper times.

Each camshaft 20, 21, which drives the valves 17, 18, can extend in a generally vertical direction and can be journaled by bearings disposed between a cam cap 22 and the cylinder head 14.

The crankshaft 12 can extend vertically in the crank chamber 29 that can be defined by a front portion of the cylinder block 15 and the crankcase 16. A driven pulley 24, 25 can be coupled to a top end of each camshaft 20, 21. A drive gear 26 can be coupled at a top end of the crankshaft 12. The drive gear 26 can engage a middle gear 27a. A timing belt 28 can be wound around a drive pulley 27b, which can be coaxially provided with the middle gear 27a, and the respective driven pulleys 24 and 25. The timing belt 28 can transmit the rotation of the crankshaft 12 to the camshafts 20, 21 of the intake and exhaust valves 17, 18.

The driven pulleys 24, 25 of the respective camshafts 20, 21 can be positioned closely to each other so that the driven pulleys 24, 25 do not protrude largely from a profile of the entire engine body, which, in turn, has a similar profile of the top cowling 700 in a top plan view. Also, the timing belt 28 can be wound around the drive pulley 27b and the respective pulleys 24, 25 in such a manner that the entire body of the belt 28 is positioned in the profile of the entire engine body.

The engine 10 in this embodiment can have a structure such that a fuel injector 60 is disposed between each intake passage 45 of the cylinder head 14 and the respective intake valve 17, which is a component of the valve drive unit. Each fuel injector 60 can have a fuel inlet port 61 at a top end thereof. A feed pipe 62 can be fitted into the fuel inlet port 61. Each fuel injector 60 can be connected to a fuel hose 63 through the feed pipe 62. The fuel injector 60 can be an injector for spraying fuel based upon injection signals computed as is known in the art by an electronic control unit which is not shown. In one embodiment, each illustrated fuel injector 60 can have a solenoid valve type nozzle.

The cylinder head 14 can be made of aluminum and produced by casting. Each cylinder can have a pair of the intake and exhaust valves 17 and 18. The cylinder head 14 of each cylinder can have valve drive unit mounting portions 14a and 14b where the intake and exhaust valves 17, 18 are coupled to the cylinder head 14. The cylinder head 14 of each cylinder can also have a spark plug mounting portion 14c, where a spark plug 44 is coupled to the cylinder head 14. The respective mounting portions 14a, 14b, 14c can be produced by casting together with the remainder of the cylinder head 14. A valve drive unit A1 which includes a valve retainer 51a other than the intake valve 17, the valve guide 50a and the valve spring 52a can be coupled to the valve drive unit mounting portion 14a, while a valve drive unit B1 which includes a valve retainer 51b other than the exhaust valve 18, the valve guide 50b and the valve spring 52b can be coupled to the valve drive unit mounting portion 14b. That is, the engine 10 in the illustrated embodiment can have valve drive unit mounting structures A and B including the valve drive units A1 and B1 and the casted valve drive unit mounting portions 14a and 14b, respectively. A spark plug 44 can be coupled to the spark plug mounting portion 14c.

Also, the cylinder head 14 of each cylinder can also have a fuel injector mounting portion 14d, which can also be produced by casting together with the remainder of the cylinder head 14. The fuel injector 60 can be coupled to the fuel injector mounting portion 14d. That is, the engine 10 in this embodiment can have a fuel injector mounting structure C including the fuel injector 60 and the casted fuel injector mounting portion 14d.

As shown in FIG. 4, in this embodiment, each valve drive unit mounting portion 14a and the respective fuel injector mounting portion 14d can at least partially overlap with each other when looked from a location of the crankshaft 12 and in a direction of an axis of the crankshaft 12. The overlap area is indicated by the reference numeral 14e in FIG. 4. In addition, a center axis L1 of each fuel injector 60 can be directed toward a shade-like portion 17b of the valve 17 by being shifted from an end of curved surface 17a located below a neck of the intake valve 17, which is part of the valve drive unit A1.

As shown in FIG. 4, a side wall 14a1 defining a space K1 in which support parts of each intake valve 17 can be housed can have a basic thickness d1 of the cast cylinder head 14. In other words, the basic thickness d1 is a thickness of the cylinder head 14 that can be determined in consideration of keeping sufficient rigidity to sustain the support parts of the intake valve 17, which is the part of the valve drive unit A1, and in consideration of making the cylinder head 14 light. As shown in FIGS. 3 and 4, in the illustrated embodiment, the side wall 14a1 can extend in a direction generally parallel to the axis L2 of the intake valve 17.

Each fuel injector mounting portion 14d can have another basic thickness d2 of the cast cylinder head 14. In other words, the basic thickness d2 is another thickness of the cylinder head 14 that can be decided in consideration of keeping sufficient rigidity to sustain the fuel injector 60 and in consideration of making the cylinder head 14 light. As shown in FIGS. 3 and 4, the mounting portion 14d can form an annular boss having a radial diameter or thickness d2. The boss can extend and be centered generally about the injection axis L1 of the fuel injector 60 towards the intake port 45a

In the illustrated embodiment, the valve drive unit mounting portion 14a and the fuel injector mounting portion 14d at least partially overlap (as shown by the overlap area 14e of FIG. 4) with each other when looked from the location of the crankshaft 12 and in the direction of the axis of the crankshaft 12. Thus, the fuel injector 60 can be positioned closer to the intake valve 17, and an angle D formed by a center axis L2 of the intake valve 17 and the center axis L1 of the fuel injector 60 can be reduced and kept relatively small. As a result, a difference between a protruding portion of the cylinder head 14 and a protruding portion of the fuel injector 60 can be small, and thus the size of the engine 10 can be reduced. Also, because the fuel injector 60 can be positioned much closer to the center axis L2 of the intake valve 17, the injection axis of the fuel injector 60 does not intersects significantly with the area of the inner surface of the intake passage 45. Thus, the configuration of the intake passage 45 does not need to be limited.

With continued reference to FIG. 4, as shown, an extension of the valve drive unit mounting portion 14a in the direction parallel to the intake valve axis L2 overlaps an extension of the annular boss of the fuel injector 60 which extends along the center axis L2 of the fuel injector. The overlap area 14e has a thickness approximately equal to d2 or d1 (or whichever is greater).

The outboard motor 1 often operates under a full throttle condition. That is, the engine 10 frequently operates in a high speed range. The intake valve 17, in the high speed range, rapidly moves between open and closed positions, and the fuel injector 60 almost continuously sprays fuel. Thus, air is taken at almost the same time as the injection. Because the injected fuel can be affected by the flow of the intake air, the air/fuel mixture is not evenly charged. However, in the illustrated embodiment, the center axis L1 of the fuel injector 60 is directed toward the shade-like portion 17b by being shifted from the end of curved surface 17a located below the neck of the intake valve 17, which forms part of the valve drive unit A1, so that the injection axis is shifted toward the shade-like portion 17b from the end of curved surface 17a located below the neck of the intake valve 17. The fuel flowing along the intake air thus can be evenly taken through the intake port.

In the cylinder head 14, the valve drive unit mounting portion 14a has the basic thickness d1 of the cast portion, and the fuel injector mounting portion 14d has the basic thickness d2 of the cast portion. That is, those portions 14a and 14d are preferably thinly cast portions given due consideration to the structural integrity of the engine 10. The fuel injector 60 thus can be positioned much closer to the intake valve 17.

The center axis L1 of the fuel injector 60 can be varied under a condition that the injection axis is fixed toward the shade-like portion 17b by being shifted from the end of curved surface 17a located below the neck of the intake valve 17. Thus, wide varieties of arrangements of the fuel injector 60 can be provided.

In this embodiment, as shown in FIG. 2, the engine 10 is the V-type DOHC engine in which the intake conduit 31 extends out of the cylinder head 14 to be coupled therewith, and the valve drive unit has the rocker type cam mechanism. The camshaft 20 thus can be positioned more inside of the cylinder head further reducing the size of the engine The fuel injector 60 can be positioned much closer to the intake valve 17, accordingly.

Also, as shown in FIG. 5, in the illustrated embodiment, an anode 71 can be fixed or coupled to the cylinder head 14, which can be exposed to a water jacket 70. The anode 71 can inhibit the water jacket 70 from being electrolytically corroded. The cylinder head 14 can have a mounting portion 14f of the anode 71, which can be formed by casting. A pipe 72 can extend through an aperture of the head cover 19. A bottom end of the pipe 72 can be press-fitted into the mounting portion 14f of the anode 71. Preferably, the anode 71 can be detachable through the pipe 72. A seal member 73 can tightly close the remainder of the aperture around the pipe 72 that extends through the aperture.

Conventionally, in general, the aperture for the anode 71 can be positioned at a wall of an oil chamber of the cylinder head 14. In this conventional structure, it is difficult to exchange the anode for a new one. In addition, cooling water can leak out while they are exchanged and can be mingled with the oil in the oil chamber of the cylinder head 14. As shown in FIG. 5, because the pipe 72, which extends through the head cover 19, is press-fitted into the mounting portion 14f of the anode 71, the anode 71 can be easily exchanged through the pipe 72 from an outside location without removing the head cover.

If the respective camshafts 20 are positioned closer to each other to make the engine 10 more compact, the pipe 72 can slant in a plan view. However, in other embodiments, the pipe 72 only needs to be constructed in such a way that the pipe 72 can be press-fitted in the oblique direction. Conventionally, the cylinder head 14 has a cylindrical mounting portion. A gradient is often necessary to remove dies used in the casting. The cylinder head 14 thus inevitably has a useless thicker wall at the mounting portion. However, because the mounting portion 14f of the anode 71 in this embodiment only needs to have an area where the pipe 72 is press-fitted, the cylinder head 14 can be made lighter.

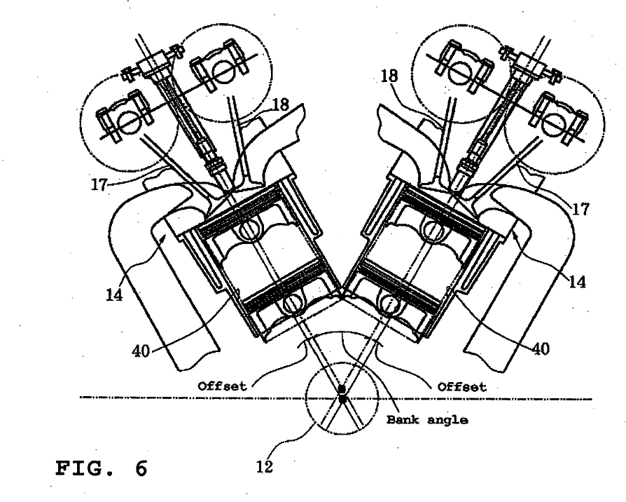

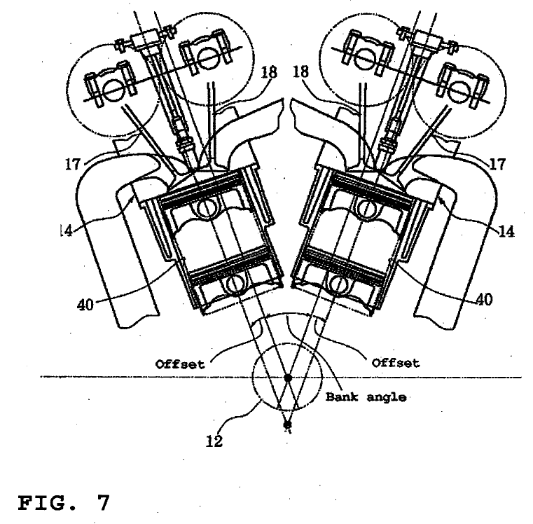

FIGS. 6 through 8 illustrate another embodiment of a V-type DOHC engine. In this embodiment, a center axis of each cylinder does not intersect with a center of the crankshaft. That is, in the side view, an offset is made between the center axis of each cylinder and a line that extends parallel to the center axis of the cylinder and intersects with the center axis of the crankshaft. FIG. 6 shows an engine 10 that has a wide bank angle, while FIG. 7 shows another engine 10 that has a narrow bank angle.

In the engine 10 shown in FIG. 6 and having the wide bank angle, the center axes of the respective cylinders are positioned inside of the lines intersecting with the center axis of the crankshaft. The cylinder head 14 can be smaller in the transverse direction. Also, in the engine 10 shown in FIG. 7 and having the narrow bank angle, the center axes of the respective cylinders 40 are positioned outside of the lines intersecting with the center of the crankshaft. The right and left banks thus can be sufficiently spaced apart from each other, and the cylinder arrangement can have narrower bank angle. Consequently, the cylinder head 14 can be smaller in the transverse direction.

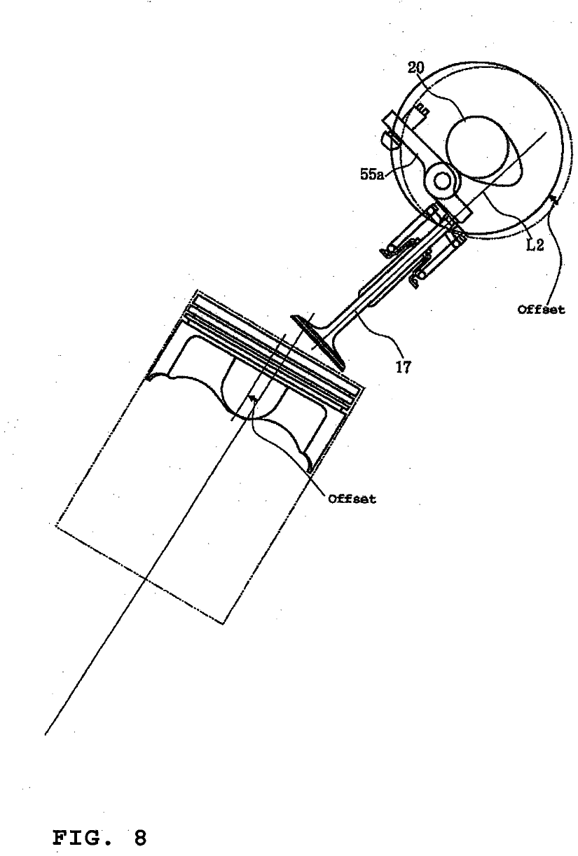

As shown in FIG. 8, in the engine 10 shown in FIG. 7 and having the narrow bank angle, if the rocker arm 55a of a roller type is used in the valve drive unit, each camshaft 20 can be positioned inside more than a center axis L2 of the respective intake valve 17. Each pulley thus can be positioned more inside to make the engine smaller in the transverse direction.

In the embodiments described above, the valve drive unit mounting portion and the fuel injector mounting portion can at least partially overlap with each other when looked from the location of the crankshaft and in the direction of the axis of the crankshaft. Thus, the fuel injector can be positioned closer to the intake valve, and an angle formed by a center axis of the intake valve and the center axis of the fuel injector can be small. Also, the center axis of the fuel injector can directed toward the shade-like portion of the valve by being shifted from the end of curved surface located below the neck of the intake valve, which forms part of the valve drive unit, so that the injection axis is shifted toward the shade-like portion from the end of curved surface located below the neck of the intake valve. The fuel flowing along the intake air thus can be more evenly taken through the intake port.

Thus, the fuel injector can be positioned closer to the valve, and an angle formed by a center axis of the intake valve and a center axis of the fuel injector can be small. As a result, a difference between a protruding portion of the cylinder head and a protruding portion of the fuel injector can be smaller reducing the size of the engine. Also, because the fuel injector can be positioned much closer to the center axis of the intake valve, the injection axis of the fuel injector hardly intersects with the area of the inner surface of the intake passage, and the configuration of the intake passage does not need to be limited.

In another embodiment, the valve drive unit mounting portion can have the basic thickness of the cast portion and the fuel injector mounting portion can have the basic thickness of the cast portion. The basic thickness can be determined by minimum thickness required to maintain structural integrity of the engine. The fuel injector thus can be positioned much closer to the valve.

In another embodiment, the center axis of the fuel injector can be varied under a condition that the injection axis is fixed toward the shade-like portion by being shifted from the end of curved surface located below the neck of the valve. Thus, wide varieties of the positioning of the fuel injector can be provided

Outboard motors often operate under a full throttle condition. That is, the engine frequently operates in a high speed range. The intake valve, in the high speed range, rapidly moves between open and closed positions, and the fuel injector almost continuously sprays fuel. Thus, air is taken at almost the same time as the injection, and the injected fuel can be affected by the flow of the intake air. According, the center axis of the fuel injector can be placed toward the shade-like portion by being shifted from the end of curved surface located below the neck of the valve, which forms part of the valve drive unit, so that the injection axis is shifted toward the shade-like portion from the end of curved surface located below the neck of the valve. The fuel flowing along the intake air thus can be evenly taken through the intake port.

The engine can be a V-type DOHC engine in which the intake conduit extends out of the cylinder head to be coupled therewith, and the valve drive unit has the rocker type cam mechanism. A camshaft thus can be positioned closer to a center of the cylinder head. The fuel injector can be positioned closer to the valve, accordingly.

In addition, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, it is contemplated that various aspects and features of the invention described can be practiced separately, combined together, or substituted for one another, and that a variety of combinations and subcombinations of the features and aspects can be made and still fall within the scope of the invention. Thus, it is intended that the scope of the present invention herein disclosed should not be limited by the particular disclosed embodiments described above, but should be determined only by a fair reading of the claims that follow.

What is claimed is:

1. An internal combustion engine, comprising:
an intake conduit;
a valve drive unit configured for driving an intake valve;
a fuel injector; and
a cylinder head that is formed by casting, the intake conduit being coupled to an intake port formed in the cylinder head through an intake passage also formed in the cylinder head, the fuel injector being positioned between the intake passage and the valve drive unit;
wherein the cylinder head further comprises a valve drive unit mounting portion and a fuel injector mounting portion, the valve drive unit mounting portion and the fuel injector mounting portion at least partially overlapping with each other when looking in a direction of an axis of the crankshaft.

2. The engine according to claim 1, wherein the valve drive unit mounting portion has a thickness that provides sufficient rigidity to support the valve drive unit and the fuel injector mounting portion has thickness that provides sufficient rigidity to support the fuel injector.

3. The engine according to claim 2, wherein the thicknesses of the valve drive unit mounting portion and the fuel injector mounting portion are minimized to reduce the weight of the engine.

4. The engine according to claim 1, wherein an injection axis of the fuel injector is directed towards a portion of the intake valve further away from an end of curved surface located below a neck of the intake valve.

5. The engine according to claim 1, wherein a center axis of the fuel injector is directed towards a portion of the intake valve further away from an end of curved surface located below a neck of the intake valve.

6. The engine according to claim 1, wherein the engine is a V-type, DOHC engine in which the intake conduit extends out of the cylinder head to be coupled therewith.

7. The engine according to claim 1, wherein the valve drive unit has a rocker type cam mechanism.

8. The engine according to claim 1 wherein the engine is configured for an outboard motor and has a generally vertically extending crankshaft.

9. An internal combustion engine, comprising:
a cylinder head that is formed by casting, the cylinder head, forming at least in part an intake port that is in communication with a combustion chamber and an intake passage that extends from the intake port,
an intake conduit in fluid communication with the intake passage,
a valve drive unit configured for driving an intake valve that is configured to at least partially open and close the intake port; and
a fuel injector that is positioned between the intake passage and the valve drive unit;
wherein the cylinder head further comprises a valve drive unit mounting portion and a fuel injector mounting portion, the valve drive unit mounting portion defining at least in part a wall having a thickness and having an extension that extends in a direction generally parallel to a longitudinal axis of the intake valve toward the intake port, the fuel injector mounting portion forming an annular boss having a radial thickness and an extension that extends generally about an injection axis of the fuel injector towards the intake port, the extensions of the valve drive unit mounting portion and the fuel injector mounting portion at least partially overlapping with each other when looking in a direction of an axis of the crankshaft.

10. The engine according to claim 9, wherein the valve drive unit mounting portion has a thickness that provides sufficient rigidity to support the valve drive unit and the fuel injector mounting portion has thickness that provides sufficient rigidity to support the fuel injector.

11. The engine according to claim 10, wherein the thicknesses of the valve drive unit mounting portion and the fuel injector mounting portion are minimized to reduce the weight of the engine.

12. The engine according to claim 9, wherein an injection axis of the fuel injector is directed towards a portion of the intake valve further away from an end of curved surface located below a neck of the intake valve.

13. The engine according to claim 9, wherein a center axis of the fuel injector is directed towards a portion of the intake valve further away from an end of curved surface located below a neck of the intake valve.

14. The engine according to claim 9, wherein the engine is a V-type, DOHC engine in which the intake conduit extends out of the cylinder head to be coupled therewith.

15. The engine according to claim 9, wherein the valve drive unit has a rocker type cam mechanism.

16. The engine according to claim 9, wherein the engine is configured for an outboard motor and has a generally vertically extending crankshaft.

17. An internal combustion engine, comprising:
a cylinder head that is formed by casting, the cylinder head, forming at least in part an intake port that is in communication with a combustion chamber and an intake passage that extends from the intake port,
an intake conduit in fluid communication with the intake passage,
a valve drive unit configured for driving an intake valve that is configured to at least partially open and close the intake port;
a fuel injector that is positioned between the intake passage and the valve drive unit;
means for supporting the valve drive unit;
means for supporting the fuel injector mounting portion; and
wherein the means for supporting the valve drive unit and means for supporting the fuel injector mounting portion at least partially overlap with each other when looking in a direction of an axis of the crankshaft.

18. The engine according to claim 17, wherein the engine is a V-type, DOHC engine in which the intake conduit extends out of the cylinder head to be coupled therewith.

19. The engine according to claim 17, wherein the valve drive unit has a rocker type cam mechanism.

20. The engine according to claim 17, wherein the engine is configured for an outboard motor and has a generally vertically extending crankshaft.
